(19) United States
(12) Patent Application Publication
(10) Pub. No.: US 2002/0020767 A1
(43) Pub. Date: Feb. 21, 2002

(54) Showerhead and liquid raw material supply apparatus using the same

(76) Inventor: Sung Gyu Pyo, Kyungki-Do (KR)

Correspondence Address: Finnegan, Henderson, Farabow,, Garrett & Dunner, L.L.P., 1300 I Street, N.W., Washington, DC, 20005-3315, US

(21) Appl. No.: 09/883,242

(22) Filed: Jun. 19, 2001

(30) Foreign Application Priority Data
Jun. 19, 2000 (JP) 2000-33608

(51) Int. Cl. B05B 7/06; B05B 1/26; B05B 1/14

(52) U.S. Cl. 239/548; 239/552; 239/566; 239/432; 239/500; 239/504; 239/522; 239/518

(57) ABSTRACT

Disclosed is a showerhead and a liquid raw material supply apparatus using the same. The liquid raw material supply apparatus comprises a carrier gas supply tube for supplying a carrier gas, a precursor supply tube connected to a given portion of the carrier gas supply tube, for supplying a precursor of a liquid state, a liquid mass flow controller installed at a given portion of the precursor supply tube, for controlling the supply amount of the precursor, and a showerhead including a first baffle connected to an end portion of the carrier gas supply tube facing the end portion of the carrier gas supply tube, the first baffle has a plurality of holes for spraying a misted precursor at the bottom of the showerhead. A second baffle is installed below the first baffle.

### BACKGROUND OF THE INVENTION

1. Field of the Invention

The invention relates generally to a showerhead and a liquid raw material supply apparatus using the same. More particularly, the present invention relates to a showerhead for converting raw materials from a liquid state into a gas state to supply them into a chamber in the manufacturing process of a semiconductor device, and a liquid raw material supply apparatus using the same.

2. Description of the Prior Art

Generally, as the integration level and the speed of semiconductor devices increases, Copper (Cu) is increasingly used as a material for metal wiring. Cu may be deposited by means of physical vapor deposition (PVD) methods, organic metal chemical vapor deposition (MOCVD) methods, electroplating methods, and electroless-plating methods. In the case of depositing Cu by means of a CVD method, since Cu raw materials in a liquid state must be converted into a gaseous state a liquid raw material supply apparatus, such as a bubbler is used.

In a conventional bubbler, a carrier gas is supplied into a container in which a raw material, that is, a precursor in a liquid state is contained. The precursor is mixed with a carrier gas at a constant ratio to create bubbles. Then, the bubbles are supplied into the process chamber. At this time, the mixing ratio of the carrier gas with the liquid raw material is determined by the flow volume of the carrier gas, and the temperature and pressure within the bubbler.

Since the Cu raw material in a liquid state must be at a low vapor pressure and maintained at a constant temperature upon deposition, it is difficult to use in the bubbler constructed as described above. When Cu is deposited using the bubbler, if the temperature of the liquid raw material is not maintained constant upon deposition, particles are generated due to dissolution of the liquid raw material, causing degradation of the film quality of a thin Cu film. In this case, it is also difficult achieving uniform film quality through deposition processes that are repeatedly performed. In addition, there is a problem that the yield of devices is lowered due to low deposition speed.

As such, a thin Cu film is deposited using a liquid delivery system including a controller for controlling the supply amount of a precursor and a vaporizer for vaporizing the precursor supplied from the controller. In case of using a liquid raw material such as a Cu precursor having a low stream pressure and being easily dissolved, a phenomenon occurs in which the raw material is dissolved in the vaporizer clogging the tube of the vaporizer. Therefore, it is difficult to uniformly deposit a thin film even when the thin Cu film is deposited using the liquid delivery system. Also, when the deposition process is continuously performed, the period of the deposition process is shortened and the reappearance of the film quality is degraded.

### SUMMARY OF THE INVENTION

The present invention provides a showerhead and a liquid raw material supply apparatus using the same, capable of solving the abovementioned problems, in which a precursor in a liquid state, supplied through a carrier gas supply tube, collides against a baffle installed within a showerhead and is then misted.

In order to accomplish the above, a showerhead according to the present invention comprises a first baffle installed within the showerhead and facing the end portion of a carrier gas supply tube, and a second baffle installed below the first baffle. A precursor in a liquid state, supplied through the carrier gas supply tube, collides against the first baffle so that the precursor is misted. The precursor is then uniformly sprayed through the second baffle.

Also, a liquid raw material supply apparatus according to the present invention comprises a carrier gas supply tube for supplying a carrier gas, a precursor supply tube connected to a given portion of the carrier gas supply tube, for supplying a precursor in a liquid state, a liquid mass flow controller installed at a given portion of the precursor supply tube, for controlling the supply amount of the precursor, and a showerhead including a first baffle connected to an end portion of the carrier gas supply tube facing the end portion of the carrier gas supply tube, and a second baffle installed below the first baffle. The showerhead has a plurality of holes at the bottom of the showerhead for spraying a misted precursor.

In addition, a method of supplying a raw material, according to the present invention, comprises colliding a precursor in a liquid state supplied from a supply tube. The precursor collides against a first battle formed facing the supply tube, so that the precursor can be misted. The misted precursor is then uniformly sprayed through a second baffle.

### BRIEF DESCRIPTION OF THE DRAWINGS

The aforementioned aspects and other features of the present invention will be explained in the following description, taken in conjunction with the accompanying drawings, wherein:

FIG. 1 shows a showerhead according to the present invention;

FIG. 2 shows a liquid raw material supply apparatus using the showerhead; and

FIG. 3 is an expanded cross-sectional view of section “A” in FIG. 2.

### DETAILED DESCRIPTION OF PREFERRED EMBODIMENTS

The present invention will be described in detail by way of a preferred embodiment with reference to accompanying drawings.

Referring now to FIG. 1, a structure of a showerhead according to the present invention will be explained below in detail.

The showerhead 4 is connected to the end of a carrier gas supply tube 1 from which a carrier gas including a precursor in a liquid state is supplied, and includes a plurality of holes 7 formed at the bottom of the showerhead 4, through which metal raw materials in a gaseous state can pass. Also, a first baffle 5 of a circular shape is formed within an upper portion of the showerhead 4, wherein the first battle 5 can face the end of the carrier gas supply tube 1. Further, a second baffle 6, having a plurality of holes and formed in a net shape, is installed below the first baffle 5.

The diameter of the carrier gas supply tube 1 is 1 to 10 mm. Also, the first baffle 5 has the diameter of 5 mm to 20 cm and the thickness of 1 mm to 10 cm. It is also separated by a distance D1 of 5 mm to 10 cm from the carrier gas supply tube 1. In addition, the first baffle 5 and the second baffle 6 are separated by a distance D2 of 1 mm to 10 cm. The second baffle 6 is separated by a distance D3 of 1 mm to 10 cm from the bottom of the showerhead. The holes 7, formed in the second baffle 6, are 0.5 to 5 mm in diameter and are arranged in any one of a regular square shape, a regular triangle shape, or a spiral shape.

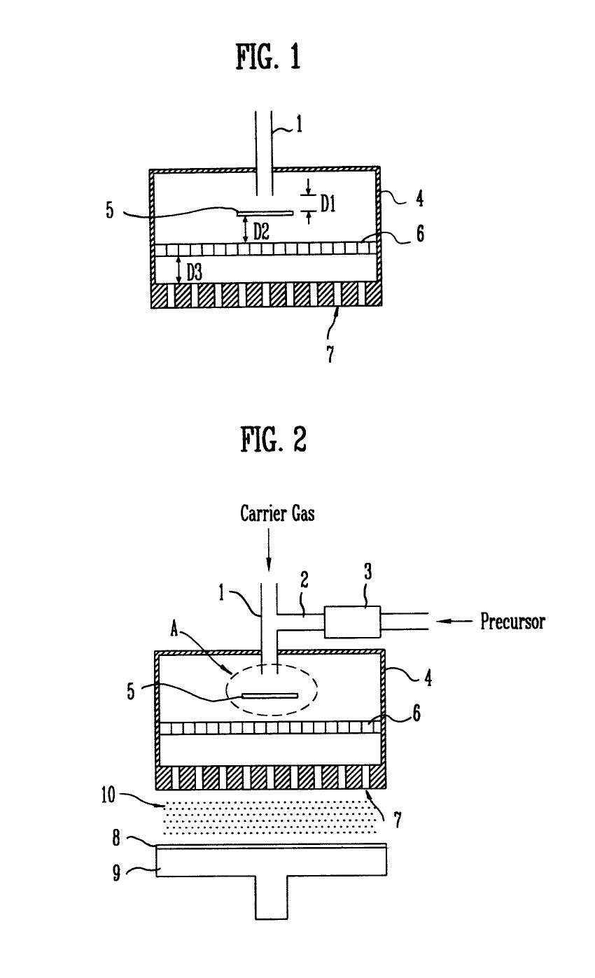

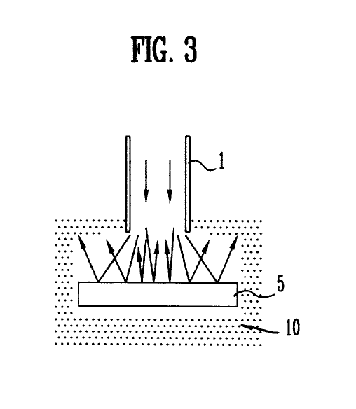

Referring now to FIG. 2, a liquid raw material supply apparatus using the showerhead 4, shown in FIG. 1, will be explained below in detail.

A precursor supply tube 2 from which a precursor in a liquid state is supplied is connected to a given portion of the carrier gas supply tube 1 from which a carrier gas is supplied. Also, a liquid mass flow controller 3 for controlling the supply amount of the precursor is connected to the precursor supply tube 2. The liquid mass flow controller 3 may include a micro pump or a liquid mass flow controller (LMFC).

The showerhead 4, as shown in FIG. 1, is connected towards the end of the carrier gas supply tube 1. The showerhead 4 is installed over a process chamber (not shown), that is, over a wafer 8 on a heater block 9.

Then, a method of depositing a thin copper (Cu) film by means of a metal organic chemical vapor deposition (MOCVD) method using the liquid raw material supply apparatus constructed as above will be explained below by reference to FIG. 3.

If a carrier gas as H₂, He, Ar, N₂ etc., is supplied at the rate of 1 to 5000 sccm through the carrier gas supply tube 1, the liquid mass flow controller 3 is operated to supply a precursor 10, such as Cu raw material in a liquid state into the carrier gas supply tube 1 through the precursor supply tube 2. The carrier gas supply tube 1 is maintained at a temperature of 5° C. lower or higher than the vaporization temperature of the precursor 10. The precursor supply tube 2 is maintained at a temperature ranging between room temperature to 100° C.

Next, the precursor 10 in a liquid state, supplied under high pressure through the carrier gas supply tube 1, collides against the first baffle 5 within the showerhead 4, as shown schematically in FIG. 3 and is then misted. At this time, by maintaining the temperature within the showerhead 4 at a temperature which facilitates vaporization of a metal raw material, for example, room temperature to 100° C., misting of the metal raw material can be facilitated by physical collision and an appropriate temperature.

The precursor 10 misted through the above processes is uniformly distributed by passing through the holes of the second baffle 6. Then, the misted precursor 10 passes through the holes 7 formed at the bottom of the showerhead 4 and is then sprayed on the surface of the wafer 8, causing the metal to be deposited on the wafer 8 by chemical reaction.

Although a deposition process using the liquid Cu raw material has been explained in the embodiment of the present invention, the present invention may employ all kinds of Cu precursors using (hfac)Cu(VTMOS), (hfac)Cu(DMB), (hfac)Cu(TMVS) series, oxides such as aluminum (Al), tantalum (Ta), TEOS, and liquid raw materials that are difficult to vaporize such as oxide or BST.

As mentioned above, according to the present invention, a precursor in a liquid state, supplied through a carrier gas supply tube, collides against a baffle installed within a shower head and is then misted. The temperature within the showerhead is maintained at the temperature for facilitating vaporization of a metal raw material. Thus, mist of the metal raw material can be facilitated by means of physical collision and an adequate temperature. Therefore, the present invention can improve the film quality due to spraying a precursor that is sufficiently misted, and can maintain preferably reappearance of the film quality due to a stable process. Also, since the present invention can mist the precursor without additional vaporizers, it can accomplish simplification of the equipment, facilitate maintenance of the equipment, reduce the consumption amount of the precursor, and lower and prevent defects of the film quality by preventing clogging of the vaporizer.

The present invention has been described with reference to a particular embodiment in connection with a particular application. Those having ordinary skill in the art and access to the teachings of the present invention will recognize additional modifications and applications within the scope thereof.

It is therefore intended by the appended claims to cover any and all such applications, modifications, and embodiments within the scope of the present invention.

What is claimed are:

1. A showerhead connected to an end portion of a carrier gas supply tube from which a carrier gas including a precursor in a liquid state is supplied and having at a surface thereof a plurality of holes through which the precursor misted can be sprayed, comprising:
a first baffle installed within the showerhead and facing said end portion of said carrier gas supply tube; and
a second baffle installed adjacent to a surface of said first baffle,
wherein the precursor in a liquid state supplied through said carrier gas supply tube collides with said first baffle so that the precursor is misted and is then uniformly sprayed through said second baffle.

2. The showerhead according to claim 1, wherein said showerhead is maintained at a temperature between room temperature and 100° C.

3. The showerhead according to claim 1, wherein said first baffle is separated by a distance of 5 mm to 10 cm from said carrier gas supply tube, said first baffle and said second baffle are separated by a distance of 1 mm to 10 cm and said second baffle is separated by the distance of 1 mm to 10 cm from a surface of the showerhead.

4. The showerhead according to claim 1, wherein the first baffle is formed in a circular shape and said second baffle is formed in a plate shape in which a plurality of holes are formed.

5. The showerhead according to claim 4, wherein the first baffle is between 5 mm and 20 cm in diameter and 1 mm and 10 cm in thickness.

6. The showerhead according to claim 4, wherein the holes formed in the second baffle are between 0.5 and 5 mm in diameter and arranged in any one of a regular square shape, a regular triangle shape, and a spiral shape.

7. A liquid raw material supply apparatus, comprising:
a carrier gas supply tube for supplying a carrier gas;
a precursor supply tube connected to a portion of said carrier gas supply tube, for supplying a precursor in a liquid state;
a liquid mass flow controller installed in a portion of said precursor supply tube, for controlling the supply amount of said precursor; and
a showerhead including a first baffle connected to an end portion of said carrier gas supply tube facing said end portion of said carrier gas supply tube, a plurality of holes at a surface of said showerhead for spraying a misted precursor, and a second baffle installed below said first baffle.

8. The liquid raw material supply apparatus according to claim 7, wherein said carrier gas supply tube is between 1 and 10 mm in diameter.

9. The liquid raw material supply apparatus according to claim 7, wherein said carrier gas supply tube is kept at a temperature 5° C. lower or higher than the vaporization temperature of said precursor.

10. The liquid raw material supply apparatus according to claim 7, wherein said first baffle is separated by a distance of 5 mm to 10 cm from said carrier gas supply tube, said first baffle and said second baffle are separated by a distance of 1 mm to 10 cm and said second baffle is separated by a distance of 1 mm to 10 cm from a surface of the showerhead.

11. The liquid raw material supply apparatus according to claim 7, wherein said first baffle is formed in a circular shape and said second baffle is formed in a plate shape in which a plurality of holes are formed.

12. The liquid raw material supply apparatus according to claim 11, wherein the diameter and the thickness of the first baffle is 5 mm˜20 cm and 1 mm˜10 cm, respectively.

13. The liquid raw material supply apparatus according to claim 11, wherein the diameter of the holes formed in the second baffle is 0.5˜5 mm and is arranged in any one of a regular square shape, a regular triangle shape, and a spiral shape.

14. The liquid raw material supply apparatus according to claim 7, where said carrier gas is one of H₂, He, Ar, and N₂ and is supplied at the rate of 1 to 5000 sccm.

15. The liquid raw material supply apparatus according to claim 7, wherein said showerhead is kept at a temperature between room temperature and 100° C. .

16. A method of supplying a raw material, comprising the steps of:
colliding a precursor in a liquid state supplied from a supply tube wherein the precursor collides with a first baffle formed facing said supply tube, thereby misting the precursor; and
uniformly spraying the misted precursor through a second baffle.
